(19) United States
(12) Patent Application Publication
(10) Pub. No.: US 2005/0079372 A1
(43) Pub. Date: Apr. 14, 2005

(54) Polyester films and methods for making the same

(76) Inventors: Michael D. Schmal, Orwigsburg, PA (US); Ernest E. Bachert, Orwigsburg, PA (US); John A. Menges, Auburn, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/843,096

(22) Filed: May 11, 2004

Related U.S. Application Data
(60) Provisional application No. 60/510,009, filed on Oct. 9, 2003.

(51) Int. Cl. F16B 4/00; B32B 27/06

(52) U.S. Cl. 428/482; 428/35.7

(57) ABSTRACT

The present invention is directed to blended monolayer films and multilayer films having odor barrier properties, methods of making such films, and bags made from such films. Blended monolayer films include blends of non-elastic polyesters and blends of non-elastic polyesters, polyester thermoplastic elastomers, polyolefins, or combinations thereof. Multilayer thermoplastic films include a plurality of layers of film. The plurality of layers of film includes at least one non-elastic polyester layer of film and at least one additional layer of film. The one additional layers of film can be polyester thermoplastic elastomer layers, polyolefin layers, nylon layers, and combinations thereof. Blended monolayer films and multilayer films are a substantial odor barrier for at least 3 days and have a gauge thickness of from about 0.00015 to about 0.01 inches.

### CROSS REFERENCE TO RELATED APPLICATIONS

The present invention claims benefit of Provisional Application Ser. No. 60/510,009, filed Oct. 9, 2003, the disclosure of which is hereby incorporated in its entirety.

### FIELD OF THE INVENTION

The present invention relates generally to thermoplastic films, products made from thermoplastic films, and methods for making the same. More particularly, the present invention relates to films having odor barrier properties, bags made from such films, and methods for making the same.

### BACKGROUND OF THE INVENTION

Undesirable odors from waste or foodstuffs are commonly retained by containers or films having odor barrier properties. Such odors are typically caused by volatile compounds, for example, hydrogen sulfide, methyl mercaptan, ethyl sulfide, dimethyl disulfide (DMDS) or diethyl disulfide (DEDS) which are often classified as small or large odor causing molecules.

The medical, pharmaceutical, and food packaging industries frequently use or manufacture products or generate waste that require a container or packaging that prevents odors from emanating from the product or waste. For example, films having odor barrier properties are used as ostomy bags, trans-dermal delivery systems, cosmetic patches, incontinence bags, medical collection bags, parenteral solution bags. Odor barrier films are also used as food packaging, as well as for protective clothing and soil fumigation applications.

Conventional films having odor barrier properties include multi-layer packaging films having gas barrier properties for use in food sanitation and environmental safety. Other conventional films include those made from amorphous non-chlorinated polymers. Conventional films also include films used in ostomy applications comprising a layer of a chlorine-free organic polymer. See for example, U.S. Pat. No. 6,355,336 to Wakabayashi, et al., U.S. Pat. No. 6,455,161 to Regnier, et al., U.S. Pat. Nos. 5,496,295, 5,658,625, and 5,643,375.

Soiled diapers are a common odoriferous waste material that require temporary storage until they are thrown away or washed. Fecal odors emanating from soiled diapers are caused in part by indoles and sulfide derivatives, such as, for example, dimethyl trisulfide, indole or 3-methyl indole.

Traditional waste containers that attempt to retain offensive odors can be classified as either a chemical odor absorber, a mechanical design that isolates waste, or an individual packaging design. A typical chemical odor absorber is disclosed in U.S. Pat. No. 5,174,462 to Hames, which uses an actuated charcoal absorber mounted in a perforated holder beneath a container lid. Although such absorbers can reduce the amount of objectionable odors that escape the container, they cannot eliminate such odors. This design also has the disadvantage of requiring periodic replacement of the charcoal media.

A mechanical design that isolates waste includes the Turn 'N Seal Diaper Pail, sold by Safety 1st. This device has a mechanism for closing the neck of a plastic liner bag, by rotating the lid of the container while in a closed position. The resealable opening approach is exemplified by U.S. Pat. No. 5,125,526 to Sumanis (the 526 patent), which discloses a garbage pail in which a bag is secured to a rotatable holder inside the pail.

An individual packaging design for infant's diapers is shown in U.S. Pat. No. 4,869,049 to Richards et al. (the 049 patent), in which a container has an inner storage chamber accessed via a closable lid and an intermediate tubular film. The device stores diapers in a series of individually wrapped packages in the storage chamber—each package being separated from adjacent packages by twists in the tube. After a diaper is deposited in the tubular film, a fixture is rotated to create a seal above the diaper.

Other conventional apparatus and methods for disposing of diapers are disclosed in U.S. Pat. No. 6,170,240 to Jacoby et al. (the 240 patent), which teaches a packaging and disposal system for sealing waste and related materials within flexible plastic tubing for odorless and sanitary disposal.

Although mechanical systems and individual packaging designs reduce the escape of offensive odors, their effectiveness depends on the odor barrier properties of the bag or flexible tubing utilized. Therefore, there is a constant need for new films having improved odor barrier properties including those polymeric films which exhibit low permeability to both small and larger odor-causing molecules.

### SUMMARY OF THE INVENTION

The present invention is directed to blended monolayer films and multilayer films having odor barrier properties, methods of making such films, and bags made from such films. Blended monolayer films include non-elastic polyesters, polyester thermoplastic elastomers, polyolefins, slip and antiblock additives, and combinations thereof. Multilayer thermoplastic films include a plurality of layers of film. The plurality of layers of film includes at least one non-elastic polyester layer of film and at least one additional layer of film. The at least one additional layer of film can include at least one polyester thermoplastic elastomer layer of film, at least one polyolefin layer of film, at least one nylon layer of film, and combinations thereof.

Non-elastic polyesters include, for example, polybutylene terepthalate, polyethylene terepthalate, and combinations thereof. Polyester thermoplastic elastomers include, for example, polyester-ester block copolymers, polyether-ester block copolymers, and combinations thereof. Polyolefins include, for example, linear low density polyethylene, low density polyethylene, high density polyethylene, polypropylene, ethylene vinyl acetate, polybutylene/polypropylene copolymers, and ultra low density polyethylene/octane copolymers. Slip additives and antiblock additives include, for example, low density polyethylene compositions composed of diatomaceous earth antiblock additives, euricamide slip additives, and thermal stabilizers.

Blended monolayer films and multilayered thermoplastic films are fabricated by extrusion techniques. Multilayered thermoplastic films are fabricated by co-extruding each of said plurality of layers of film to form said multilayered thermoplastic film. Multilayered thermoplastic films are also fabricated by extruding each layer of film separately and joining the layers by calendaring techniques, laminating techniques, melt coating, or by disposing an interleaving adhesive layer between each of the plurality of layers of film.

The films of the present invention are used to fabricate bags having odor barrier properties. Preferably, for at least 3 days, the bags provide a substantial odor barrier from odoriferous products or waste disposed in the bag. In one embodiment, the bags are tube shaped.

### BRIEF DESCRIPTION OF THE DRAWINGS

The numerous features and advantages of the present invention may be better understood by those skilled in the art by reference to the accompanying detailed description and the following drawing, in which:

FIG. 1 is a cross sectional view of an exemplary blended monolayer film;

FIG. 2A is a cross sectional view of an exemplary multi-layered monolayer film;

FIG. 2B is a cross sectional view of another exemplary multi-layered monolayer film;

FIG. 3 shows a side view of an exemplary blown film extrusion apparatus for fabricating multi-layered co-extruded films;

FIG. 4 shows a side view of an exemplary blown extrusion apparatus for blended monolayer films;

FIG. 5a shows a perspective view, partly in section, of an exemplary package disposal device;

FIG. 5b shows a cross sectional view of an exemplary package disposal device;

FIG. 6 is a side view, partly in section, of an exemplary cassette; and

FIG. 7 is a graph of oxygen and water vapor permeability coefficients for blended monolayer films.

### DETAILED DESCRIPTION OF ILLUSTRATIVE EMBODIMENTS

The present invention is directed to blended monolayer films and multilayer films having odor barrier properties, methods of making such films, and bags made from such films. Blended monolayer films include non-elastic polyesters, polyester thermoplastic elastomers, polyolefins, slip and antiblock additive and combinations thereof. Multilayer thermoplastic films include a plurality of layers of film. The plurality of layers of film includes at least one non-elastic polyester layer of film and at least one additional layer of film. The at least one additional layer of film can be at least one polyester thermoplastic elastomer layer of film, at least one polyolefin layer of film, at least one nylon layer of film, and combinations thereof.

Blended monolayer films and multilayer films form a substantial odor barrier. As used herein “substantial odor barrier” means a barrier that restricts the transmission of odors, i.e., odor causing molecules, so that odors are not detected by the olfactory system of the average human. Preferably, blended monolayer films and multilayer films are a substantial odor barrier for at least about 3 days, more preferably at least about 4 days, more preferably at least about 5 days, and even more preferably at least about 6 days.

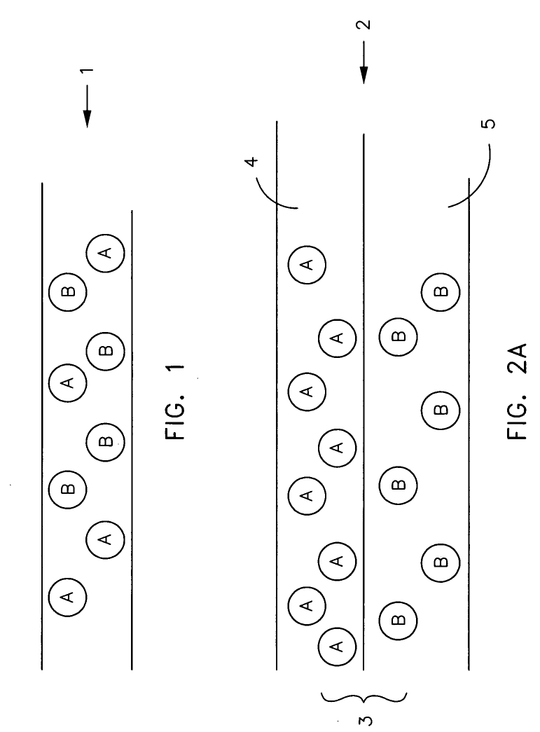

FIG. 1 is a cross sectional view of an exemplary blended monolayer film. Blended monolayer films 1 are made from melt blends of two or more non-elastic polyesters, or melt blends of non-elastic polyesters, polyester thermoplastic elastomers, polyolefins, or combinations thereof. Non-elastic polyesters are polyester based polymers having a crystallinity of at least above about 35%, and preferably at least above about 50%. For example, non-elastic polyesters include polyesters derived from a dicarboxylic acid and a diol. A description of exemplary non-elastic polyesters and the synthesis thereof can be found in the appropriate chapters of the Encyclopedia of Polymer Science and Technology (1985).

Preferred diols used to synthesize non-elastic polyesters are alkylene glycols that form long chains and thereby facilitate crystal formation. Preferred dicarboxylic acids used to synthesize non-elastic polyesters are terephthalic acids, phthalic acids, or isophthalic acids. More preferred decarboxylic acids are terepthalic acids. Preferably, non-elastic polyesters are polybutylene terephthalate, polypropylene terephthalate, and polyethylene terephthalate. Substituted dicarboxylic acids or substituted diols can be used to synthesize non-elastic polyesters.

Non-elastic polyesters are commercially available under different registered trade names. For example, Celanex® from Ticona, Arnite® from DSM Engineering, Ultradur® from BASF, and Crasting from DuPont are suitable non-elastic polyesters. A preferred non-elastic polyester is Celanex® 1700A.

Polyester based thermoplastic elastomers include polyester block copolymers, i.e., thermoplastic copolyester based elastomers (TPE-E's or COPE). Polyester block copolymers include any polyester based block copolymer having alternating substantially crystalline segments and low crystalline segments. A description of exemplary polyether-ester block copolymers, polyester-ester block copolymers, and the synthesis thereof can be found in the appropriate chapters of the Encyclopedia of Polymer Science and Technology (1985).

Preferably, polyester block co-polymers are polyether-ester block copolymers or polyester-ester block copolymers. More preferably, polyester block copolymers are polyether-ester block copolymers.

Polyether-ester block copolymers and polyester-ester block copolymers are commercially available under different trade names. For example, Arnitel® from DSM Engineering Inc., Hytrel® from DuPont and Riteflex® from Ticona are suitable polyether-ester and polyester-ester block copolymers. A preferred polyester block copolymer is the Arnitel® product line commercially available from DSM Engineering. A more preferred polyester block copolymer is Arnitel® EM630.

Polyetherester block copolymers and polyesterester block copolymers include the repeating alternating ester units of low crystallinity polyester segments A and cystallizable polyester segments B. Segment A contains amorphous polyesters, polyethers, or combinations thereof. Segment B contains crystalline or semi crystalline polybutylene terephthalate.

In one embodiment, Segment A includes polyether glycols, polyester glycols, or combinations thereof that are derived from at least one dicarboxylic acid and at least one glycol. Preferred dicarboxylic acids include aliphatic acids, cycloaliphatic acids, and aromatic acids. Preferably, the dicarboxylic acids have from about 8 to about 16 carbon atoms. Preferred dicarboxylic acids are terephthalic acids. Preferred polyalkylene glycols are long chain glycols with terminal or near terminal hydroxy groups. Preferred alkylene glycols are polyethylene oxide, poly(1,2- and 1,3) propylene oxide, polybutylene oxide, tetramethylene oxide, or copolymers thereof. Polybutylene oxide is a more preferred alkylene glycol. Segment B includes repeating units derived from at least one diol and a dicarboxylic acid. Segment B is a high crystallinity block with a preferred crystallinity above about 35%, and more preferably above about 50%. Suitable diols include aliphatic, cycloaliphatic, and aromatic dihydroxy compounds. Preferred diols have from about 2 to about 15 carbon atoms, such as ethylene, propylene, butylene, tetramethylene, etc.

“Polyolefin” as used herein includes all polyolefins known to those skilled in the art. Polyolefins include acyclic and cyclic hydrocarbons having one or more carbon-carbon double bonds, apart from the formal ones in aromatic compounds. Polyolefins subsumes alkenes and cycloalkenes and corresponding polyenes. Polyolefins also includes alkene co-polymers. The alkene polymers and alkene copolymers can be substituted with functional groups. A description of exemplary polyolefins can be found in the appropriate pages of the CRC Handbook of Chemistry and Physics, 79th ed. (1998), which is herein incorporated by reference in its entirety.

For example polyolefins include polyethylene polymers, polypropylene polymers, and polyethylene/polypropylene copolymers. Polyolefins are commercially available from, for example, Voridian or Dow. Preferred polyolefins are linear low density polyethylene, low density polyethylene, high density polyethylene, polypropylene, ethylene vinyl acetate, polyethylene/polypropylene copolymers, and ultra low density polyethylene/octene copolymers. More preferably, polyolefins are linear low density polyethylene copolymers and ultra low density polyethylene/octene copolymers. An exemplary ultra low density ethylene/octene copolymer is commercially available as Attane™ 4301G from Dow.

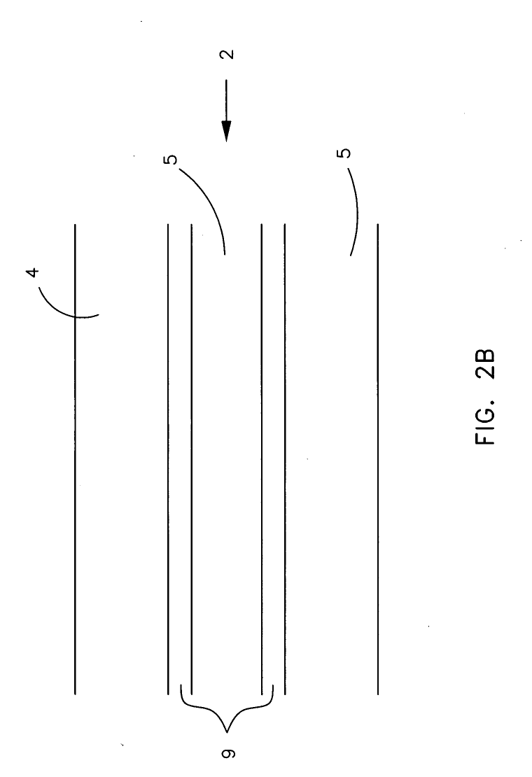

FIG. 2A is a cross sectional view of an exemplary multi-layered film. FIG. 2B is another cross sectional view of an exemplary multi-layered film. Referring to FIGS. 2A & 2B, multilayered films 2 are made of a plurality of discrete layers of film 3 that are joined together. The plurality of layers of film 3 include at least one layer of a non-elastic polyesters 4 and at least one additional layer of film 5. The at least one additional layer of film 5 is a polyester thermoplastic elastomer layer of film 6, a polyolefin layers of film 7, a nylon layer of film 8, or combinations thereof.

“Nylon” as used herein means any nylon polymer known to those skilled in the art. Nylon includes polyamides prepared by reacting diamines with diacids. “Nylon” includes commonly known polyamide polymers such as Nylon 6, and Nylon 66. Nylons are commercially available, such as for example, B4FN or KR4418 nucleated Nylon 6 from BASF.

Referring to FIG. 2B, in one embodiment, multilayered films include at least one interleaving adhesive layer 9 that is placed between layers of the plurality of layers of film 3. Each adhesive layer 3 joins two layers of film together to form the plurality of layers of film 3.

In one embodiment, blended monolayer films and multilayered films are composed of from about 25 to about 75 weight percent, based on the total weight of the film, of polyethylene terepthalate, and from about 25 to about 75 weight percent polybutylene terepthalate. Preferably, the films are from about 55 to about 65 weight percent of polyethylene terepthalate, and from about 35 to about 45 weight percent polybutylene terepthalate.

In one embodiment, blended monolayer films and multilayered films composed of non-elastic polyester and polyester thermoplastic elastomer include from about 40 to about 99 weight percent non-elastic polyester and about 1 to about 60 weight percent polyester thermoplastic elastomer. Preferably, the films are from about 60 to about 95 weight percent non-elastic polyester and from about 5 to about 40 weight percent polyester thermoplastic elastomer. More preferably, the films are about 10 weight percent polyester thermoplastic elastomer and about 90 weight percent non-elastic polyester.

Blended monolayer films and multilayered films composed of non-elastic polyester and polyolefin are from about 40 to about 99 weight percent non-elastic polyester and about 1 to about 60 weight percent polyolefins. Preferably, the films are from about 60 to about 95 weight percent non-elastic polyester and from about 5 to about 40 weight percent polyolefins. More preferably, the films include about 25 weight percent polyolefins and about 75 weight percent non-elastic polyester.

Blended monolayer films and multilayered films composed of non-elastic polyester, polyolefins, and polyester thermoplastic elastomers are from about 40 to about 99 weight percent non-elastic polyester, about 1 to about 40 weight percent polyolefins, and about 1 to about 40 weight percent polyester thermoplastic elastomers. Preferably, the films are from about 70 to about 99 weight percent non-elastic polyester, about 1 to about 15 weight percent polyolefins, and about 1 to about 15 weight percent polyester thermoplastic elastomers. More preferably, the films are from about 80 to about 90 weight percent non-elastic polyester, about 5 to about 10 weight percent polyolefins, and about 5 to about 10 weight percent polyester thermoplastic elastomers.

Blended monolayer films and multilayered films are as thin as possible in order to minimize the amount of resin necessary to fabricate the films while at the same time providing a sufficient odor barrier and maintaining physical properties, such as for example, strength and tear resistance. Preferably, blended monolayer films and multilayered films have a gauge thickness of from about 0.00015 to about 0.01 inches. More preferably, blended monolayer films and multilayered films have a total gauge thickness from about 0.00015 inches to about 0.0050 inches, and more preferably from about 0.00035 inches to about 0.0050 inches. Even more preferably, blended monolayer films and multilayered films have a total gauge thickness from about 0.00050 inches to about 0.0010 inches.

Blended monolayer films and multilayered films may also contain film additives, such as for example, stabilizers, dyes or pigments, fillers, processing aids, heat stabilizers, anti-block additives, slip additives, fragrances, compatalizers, impact modifiers, de-odorizers, and antimicrobial agents that are known to those skilled in the art. Film additives include “concentrates” of conventional additives. Concentrates are produced by compounding additives with a base resin such as, for example, polyethylene or polybutylenes terepthalate. For example, a concentrate includes 25 percent by weight film additive and 75 percent by weight base resin, based on the total weight of the concentrate. Conventional film additives are described in U.S. Pat. No. 6,623,866 which is herein incorporated by reference in its entirety.

Fragrance concentrates include, for example, 3333-HBE baby powder available from USA Fragrances (Hazlet) and 6465 PBC baby powder available from Polyiff. Slip/antiblock concentrates include, for example, NBA 062001 available from Clariant. Fragrance/TiO2 concentrates include, for example, CC1008876, CC10020219, CC10020130, and CC10020879 available from PolyOne.

Slip and antiblock additives decrease the force of friction between the film and an object in contact with the film thereby providing “slipperiness” to the film. Slip additives include, for example, higher aliphatic acid amides, higher aliphatic acid esters, waxes and metal soaps which can be used in amounts ranging from about 0.1 to about 2 weight percent based on the total weight of the layer. A specific example of a useful fatty amide slip additive is erucamide.

Antiblock additives include, for example, amorphous silica, calcium carbonate, magnesium silicate, aluminum silicate, calcium phosphate, or combinations thereof. Typical organic anti-block additives that may be used in multilayer films include, but are not limited to, crosslinked polymethacrylate (EPOSTAR MA, available from Nippon Shokubai), polymethylsilsesquioxane (TOSPEARL, available from Toshiba Silicon Co.), benzoguanamine formaldehyde, polycarbonate, polyamide, polyester, polytetrafluoroethylene (TEFLON) powder, or combinations thereof. Also contemplated are combinations of organic and inorganic anti-block additives.

In one embodiment, film additives include blends of slip additives and/or antiblock additives that form a slip/antiblock composition, i.e., “slip/antiblock concentrate”. Slip/antiblock compositions are composed of a polyethylene polymer blended with at least one antiblock additive, at least one slip additive and at least one thermal stabilizer. Thermal stabilizers include those known to those skilled in the art, such as for example Iragnox 1098 which is commercially available from Ciba Corporation. Slip/antiblock compositions are commercially available, for example, from Plastics Color & Compounding, Inc.

Preferably, slip/antiblock compositions include from about 60 to about 70 weight percent, based on the total weight of said slip and antiblock additive, of low density polyethylene; from about 20 to about 30 weight percent, based on the total weight of said slip and antiblock additive, of diatomaceouse earth antiblock additive; from about 1 to about 10 weight percent, based on the total weight of said slip and antiblock additive, of euricamide slip additive; and from about 1 to about 5 weight percent, based on the total weight of said slip and antiblock additive, of a thermal stabilizer.

In one embodiment, slip/antiblock compositions include about 67.5 weight percent, based on the total weight of the slip and antiblock additive of low density polyethylene, about 25 weight percent, based on the total weight of the slip and antiblock additive of diatomaceous earth antiblock additive, about 5 weight percent, based on the total weight of the slip and antiblock additive of euricamide slip additive, and about 2.5 weight percent, based on the total weight of the slip and antiblock additive of thermal stabilizer. This slip/antiblock compositions is commercially available as PELD 1074, from Plastics Color & Compounding, Inc.

Blended monolayer films and multilayered films include from about 0.1 to about 10 weight percent slip/antiblock composition. Preferably, the films include from about 1 to about 5 weight percent slip/antiblock composition. More preferably, the films include from about 1 to about 5 weight percent slip/antiblock composition.

In one embodiment, blended monolayer films and multilayered films are composed of polybutylene terepthalate, ultra low density polyethylene/octene copolymer, and a slip/antiblock composition composed of 67.5 weight percent, based on the total weight of the slip and antiblock additive of low density polyethylene, 25 weight percent, based on the total weight of the slip and antiblock additive of diatomaceous earth antiblock additive, 5 weight percent, based on the total weight of the slip and antiblock additive of euricamide slip additive, and 2.5 weight percent, based on the total weight of the slip and antiblock additive of thermal stabilizer.

In another embodiment, blended monolayer films and multilayered films are composed of 70 weight percent polybutylene terepthalate, about 25 percent by weight ultra low density polyethylene/octene copolymer, and about 5 percent by weight of a slip/antiblock composition comprising 67.5 weight percent, based on the total weight of the slip and antiblock additive of low density polyethylene, 25 weight percent, based on the total weight of the slip and antiblock additive of diatomaceous earth antiblock additive, 5 weight percent, based on the total weight of the slip and antiblock additive of euricamide slip additive, and 2.5 weight percent, based on the total weight of the slip and antiblock additive of thermal stabilizer.

In one embodiment, blended films and multilayer films contain 1 weight percent baby powder fragrance and titanium dioxide concentrate, and about 4 weight percent talc and slip additive concentrate, based on the total weight of the film. In another embodiment, blended films and multilayer films contain about 1 weight percent fragrance and titanium dioxide concentrate, and about 2 weight percent talc and slip additive concentrate, based on the total weight of the film. In another embodiment, blended films and multilayer films contain about 1 weight percent fragrance and titanium dioxide concentrate, and about 1.5 weight percent talc and slip additive concentrate, based on the total weight of the film. In another embodiment, blended films and multilayer films contain about 1 weight percent titanium dioxide concentrate, and about 3 weight percent fragrance concentrate, based on the total weight of the film. In another embodiment, blended films and multilayer films contain about 2 weight percent fragrance concentrate, based on the total weight of the film. In another embodiment, blended films and multilayer films contain about 1 weight percent fragrance concentrate and about 1 weight percent slip additive concentrate, based on the total weight of the film. In another embodiment, blended films and multilayer films contain about 1.5 weight percent fragrance concentrate, and about 4.5 weight percent slip additive concentrate, based on the total weight of the film. In another embodiment, blended films and multilayer films contain about 1 weight percent fragrance concentrate, about 2 weight percent slip additive concentrate, and about 2 weight percent titanium dioxide concentrate, based on the total weight of the film. In another embodiment, blended films and multilayer films contain about 2 weight percent slip/antiblock concentrate, and about 3 weight percent fragrance concentrate, based on the total weight of the film.

Blended monolayer films and multilayer films include up to 10 weight percent of at least one film additive. Preferably, blended monolayer films and multilayer films include from about 0.025 to about 10 weight percent of at least one film additive, more preferably from about 0.5 to about 5 weight percent, and even more preferably from about 1 to about 3 weight percent.

Blended monolayer films and multilayer films are useful as an odor barrier for use in, for example, the waste disposal industry, the food handling industry, or the medical industry. Blended monolayer films and multilayer films can be used as, for example, bags to hold soiled diapers, ostomy bags, trans-dermal delivery systems, cosmetic patches, incontinence bags, medical collection bags, parenteral solution bags, and food packaging, as well as for protective clothing and soil fumigation applications.

Methods of fabricating blended monolayer films and multilayer films include extrusion and co-extrusion techniques. A description of exemplary extrusion processes and co-extrusion processes can be found in Perry's Chemical Engineering Handbook, Ch. 18, pp. 29-32 (1997) which is herein incorporated by reference.

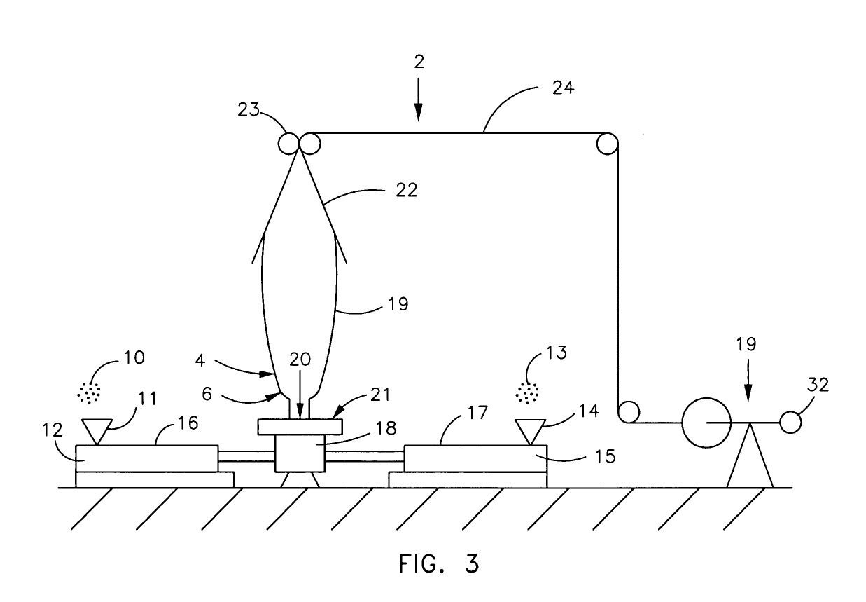

FIG. 3 shows a side view of an exemplary blown film extrusion apparatus for fabricating multi-layered films 2 using co-extrusion techniques. Multi-layered co-extruded films of the present invention are made by pouring non-elastic polyester resin pellets 10 into the resin hopper 11 of a first extruder 12 and pouring polyester thermoplastic elastomer resin pellets 13 and/or polyolefin resin pellets (not shown) into the resin hopper 14 of a second extruder 15. Any conventional type of extruder may be used, including, single screw, double screw, and/or tandem extruders. Non-elastic resin pellets 10 from the resin hopper 11 of the first extruder 12 are fed into the first extruder 12 and polyester thermoplastic elastomer resin pellets 13 from the resin hopper 14 of the second extruder 15 are fed into the second extruder 15. The non-elastic resin pellets 10 and the polyester thermoplastic elastomer resin pellets 13 are melted in the first extruder 12 and the second extruder 15 respectively to form melted resins of non-elastic polyester 16 and polyester thermoplastic elastomer 17. Any optional additives that are used may be added to melted resins 16 and 17 in first extruder 12 and second extruder 15 and/or may be added with resin pellets 10 and 13. The first extruder 12 and the second extruder 15 are connected at their end by a die 18.

The first extruder 12 and second extruder 15 push melted resins 16 and 17 through die 18 to form a film of non-elastic polyester 4, or first layer, and a film of polyester thermoplastic elastomer 6, or second layer. Preferably, die 18 permits a film of non-elastic polyester film 4 and a second film of polyester thermoplastic elastomer 6 to be extruded simultaneously to form a multi-layered film 2 once cooled.

Non-elastic polyester film 4 and polyester thermoplastic elastomer film 6 exit die 18 and are cooled by contacting a region of reduced temperature and pressure relative to the temperature and pressure within the first extruder 12 and second extruder 15. Typically, the region of reduced temperature and pressure is the ambient atmosphere, but may also include being rolled onto a chilled roller or being contacted with a chilled air flow. For example, films 4 & 6 can be cooled by blowing air onto their surface using an annular device, i.e., air ring 21, that is known to those skilled in the art. The sudden reduction in temperature and pressure causes the non-elastic polyester film 4 and polyester thermoplastic elastomer film 6 to solidify upon cooling to form the multi-layered film 2. The multilayered film 2 is gathered by a winder that winds the film into rolls.

In one embodiment, the multi-layered film is co-extruded in a blown film extrusion process. The die 18 connecting the first extruder 12 and the second extruder 15 in a blown film process is annular, or ring-shaped, such that the first extruder 12 and second extruder 15 force non-elastic polyester film 4 and polyester thermoplastic elastomer film 6 out of die 18 in the shape of a tube 19. Die 18 has an aperture 20 positioned in the center of its top face and an ring 21. Aperture 20 permits a blowing agent to inflate tube 19 of non-elastic polyester film 4 and polyester thermoplastic elastomer film 6 as it exits die 18. The blowing agent increases the tube 19 diameter and decreases its thickness. Tube 19 is blown against a collapsing frame 22 that guides the tube into a pair of rollers 23. The rollers 23 flatten the tube 19 to form a tubular stock of film 24. The tubular stock 24 is then wound into a roll 32 for transportation and storage.

Referring to FIG. 3, the multi-layered film 2 includes at least one additional layer 5. Multilayered films 2 can be fabricated by co-extruding the non-elastic polyester film layer 4 and each of the at least one additional layers 5 to form said multilayered thermoplastic film 2. Alternatively, the multi-layered thermoplastic film 2 can be fabricated by extruding a first layer of non-elastic polyester 4 and each of the at least one additional layers 5 individually. To form multi-layered films 2, the first layer 4 and one of the at least one additional layers 5 is disposed on the first layer 4. The first layer 4 and the at least one additional layers 5 are then rolled between a heated roller to form the multilayered film 2. Alternatively, the multilayered film 2 can be fabricated by disposing an interleaving adhesive layer 9 between the first layer 4 and each of the additional layers 5.

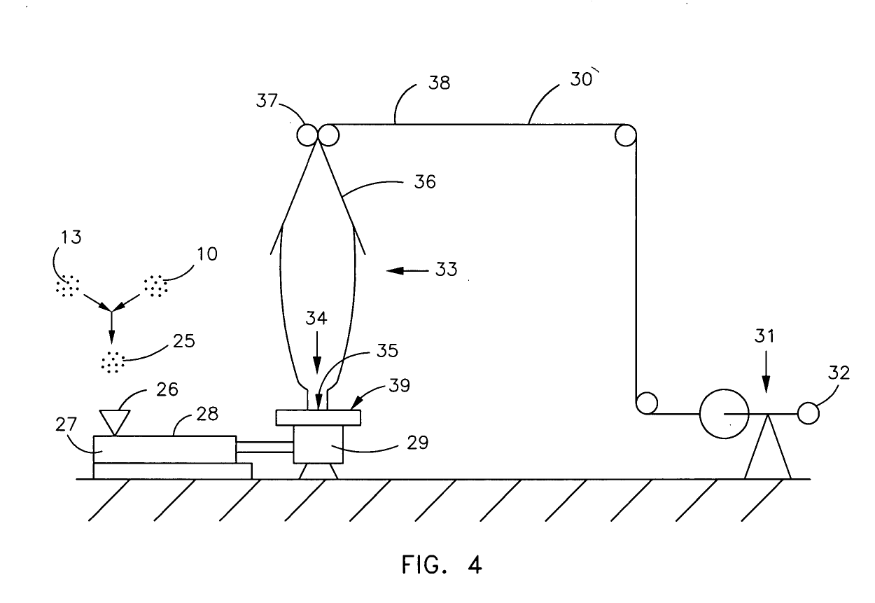

FIG. 4 shows a side view of an exemplary blown extrusion apparatus for blended monolayer films 1. Blended monolayer films are made by combining and admixing non-elastic polyester resin pellets 10 and polyester thermoplastic elastomer resin pellets 13, and/or polyolefin resin pellets (not shown) sufficiently to form a blend 25 that is substantially homogenous. Blend 25 is then poured into a resin hopper 26 of an extruder 27. Any conventional type of extruder may be used, including, single screw, double screw, and/or tandem extruders. Any optional additives that are used may be added to the melted resin in each extruder and/or may be added with resin pellets 10 and 13. Resin hopper 26 feeds blend 25 into extruder 27. Blend 25 is melted and mixed within extruder 27 to form a melt blend 28 that includes non-elastic polyesters and polyester thermoplastic elastomer. Extruder 27 pushes melt blend 28 through a die 29 at the end of extruder 28. Extruder 27 forces melt blend 28 through die 29 to form a blended monolayer film 30. As the blended monolayer film 30 exits die 29 it contacts a region of reduced temperature and pressure relative to the temperature and pressure within extruder 27. Typically, the region of reduced temperature and pressure is the ambient atmosphere, but may also include being rolled onto a chilled roller. For example, film 30 can be cooled by blowing air onto their surface using an annular device, i.e., air ring 39, that is known to those skilled in the art. The sudden reduction in temperature and pressure causes the blended film 30 to solidify upon cooling. Blended monolayer film 30 is gathered by a winder 31 that winds the blended film 30 into rolls 32.

In a preferred embodiment, melt blend 28 is extruded in a blown film extrusion process. In a blown film process, die 29 at the end of extruder 27 is annular, or ring-shaped, such that extruder 27 forces the melt blend 28 out of die 29 in the shape of a tube 33. Die 29 has an aperture 34 positioned in the center of its top face 35 and an air ring 39. Aperture 34 is annular or circular in shape to permit a blowing agent to inflate the tube 33 as it exits the die 29. The blowing agent increases the tube 33 diameter and decreases the thickness of the blended monolayer film 30 forming tube 33. Tube 33 is blown against a collapsing frame 36 that guides tube 33 into a pair of rollers 37. The pair of rollers 37 flatten tube 33 to form a tubular stock of film 38. The tubular stock of film 38 is then wound into a roll 32 for transportation and storage.

Blended monolayer films and multilayered films may be optionally stretch oriented. The term “stretch-oriented” is used herein to describe the process and resultant product characteristics obtained by stretching and immediately cooling a resinous polymeric material which has been heated to its orientation temperature so as to revise the molecular configuration of the material by physical alignment of the molecules to improve certain mechanical properties of the film such as, for example, tensile strength and tear strength, shrink properties as well as the optical properties of the film. In the context of the present invention, stretch-orientation decreases the moisture and gas transmission rates i.e., improves the moisture vapor barrier functionality of the film, and also increases the toughness and shrinkability of the film in comparison to films that are not stretch-oriented.

The film sheets are optionally stretch-oriented by reheating the quenched film sheet to its orientation temperature and then stretching the film. The orientation temperature for a given film will vary with the different resinous polymers and blends thereof which include the film, and will generally be a range of temperatures based on such factors. In general, the orientation temperature may be stated to be above room temperature and below the melting point of the film, and will typically be at or near the glass transition temperature of the resins from which the film is made.

The process of stretching a film at its orientation temperature range may be accomplished in a number of ways such as, for example, by double bubble or tenter framing techniques. These and other techniques are well known in the art and involve stretching the film in the cross or transverse direction (TD) and/or in the longitudinal or machine direction (MD). When the stretching force is applied in one direction, uniaxial orientation results. When the stretching force is applied in two directions, biaxial orientation results. After being stretched, the film is rapidly cooled to quench and thus set or locked-in the oriented molecular configuration. Such an oriented and quenched film is said to be heat-shrinkable, i.e., without heat-setting as described immediately below, the film will tend to return toward its original, unoriented (unstretched) dimensions when subsequently heated to an appropriate temperature below its melting temperature range.

After locking-in the oriented molecular configuration by quenching, film sheets may also be heat-set by bringing the oriented film to a temperature near its orientation temperature while restraining the film in its stretched dimensions. This process, which is also know as annealing, produces a film with substantially less shrinkability, while retaining much of the advantages of orientation, including improved tensile strength and optical properties, as well as lower gas and moisture transmission rates.

The films are preferably stretch-oriented in at least two directions, i.e., biaxially oriented, preferably in both the machine direction and transverse direction. Further, the films preferably have an orientation ratio of at least about 2 in both of the directions in which they have been oriented. As used herein, the phrase orientation ratio refers to the multiplication product of the extent to which a film is expanded in any one direction during the orientation process. Thus, an orientation ratio of, e.g., 2 in the machine direction, indicates that the film has been expanded to twice its original dimension in the machine direction of the film. When a film is biaxially oriented, the orientation ratios are conventionally expressed as [machine direction (MD) ratio]×[transverse direction (TD) ratio] or [TD ratio]×[MD ratio], however designated. Thus, a biaxial orientation ratio of 2 in the MD and 3 in the TD would be expressed as a MD×TD orientation ratio of 2×3.

Blended monolayer films and multilayer films are used to fabricate bags. Bags are made from flat sheets of films, by sealing three edges of two superimposed sheets of film or alternatively by folding a rectangular sheet in half and sealing the two sides proximate to the folded side, or by sealing one end of a tubular stock of film. Preferably, the bag has an opening that is sealable thereby forming a resealable bag.

Blended monolayer films and multilayer films can each be sealed by heat sealing techniques such as wire impulse sealing techniques, impulse sealing techniques, rotary heat sealing, hot knife heat sealing, or by ultrasonically sealing techniques. Preferably, ultrasonic sealing techniques are used to fabricate bags.

In another embodiment, blended monolayer films and multilayer films are fabricated in the form of tubular stock such that bags can be produced therefrom by sealing one end of a length of tubular film or by sealing both ends of the tubular film end then slitting one sidewall to form the bag mouth. In another embodiment, the tubular film includes two open ends, and a sidewall, thereby forming a tube/cylinder shape.

The bags of the present invention are fabricated using blended monolayer films or multilayer films. As used herein “bag” means any flexible container known to those skilled in the art for holding, storing, or carrying something. A bag includes a film structure having a sidewall, a closed end, and a sealable open end. For example, a bag includes waste disposal bags, bags for retaining diapers, medical bags, bags for ostomy applications, and food packaging bags.

Bags made from blended monolayer films and multilayer films are used in packaging and disposal systems for sealing waste, e.g., soiled diapers, for odorless and sanitary disposal. Bags, i.e., flexible tubing, used in disposal systems are tube shaped to facilitate a greater capacity for retaining waste. Tubular bags can be used to dispose of diapers in disposal systems, such as for example, described in U.S. Pat. Nos. 6,170,240, 5,125,526, and 4,869,049, each of which is herein incorporated by reference in its entirety.

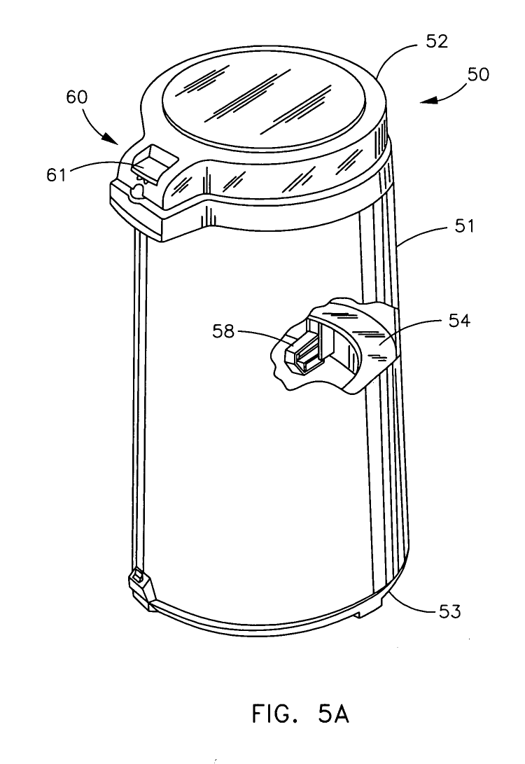

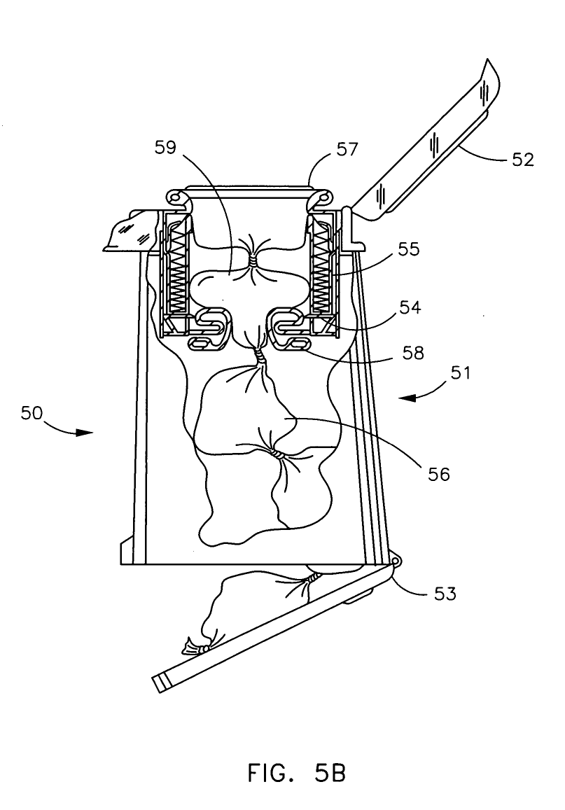

FIG. 5A shows a perspective view, partly in section, of an exemplary package disposal device. FIG. 5B shows a cross sectional view of an exemplary package disposal device. Referring to FIGS. 5A & 5B, the package disposal device 50 comprises a substantially cylindrical container 51 having a removable cover 52 at the top of the cylindrical container 51 and an access door 53 at the bottom of the cylindrical container 51. The removable cover 52 has an opening covered by a hinged lid 53. A ring-shaped flange 54 is located inside the cylindrical container 51, and a tubular core 55 rests on the flange 54. A continuous length of flexible tubing 56 is stored within the tubular core 55. A twist rim 57 is rotatably coupled to the tubular core 55. Rotating the twist rim 57 twists the flexible tubing 56.

A plurality of retention springs 58 are attached to the flange 54. The retention springs 58 hold a waste package 59 within the flexible tubing 56 stationary while the twist rim 57 rotates to twist the flexible tubing 56 and seal the end of the waste package 59. An aperture in the twist rim 57 preferably contains a clear plastic panel.

The cover 52 is removably attached to the cylindrical container 51. When the cover 52 is removed, an end of the flexible tubing 56 can be removed from the roll of flexible tubing 56 contained within the tubular core 55 and knotted. This knot of flexible tubing 56 is then placed into the cylindrical container 51 through the flange 54 toward the bottom of the cylindrical container 51 and forms a bag for storing waste packages 59. Waste packages 59 are placed into the bag formed by flexible tubing 56, and the flexible tubing 56, together with waste package 59, is held stationary by the plurality of retention springs 58 inside of the cylindrical container 51 coupled to the flange 54.

Once the waste package 59 is deposited in the flexible tubing 56 and the cover 52 is closed, the hinged lid 53 can be opened using a latch 60. The latch 60 comprises a button 61 and a latch spring 62 (not shown).

Bags of flexible tubing are stored in containers, such as for example, cassettes for dispensing the flexible tubing. When retained by the cassette, the flexible tubing is packed in a tightly layered mass. Bags for retaining diapers include, for example, the bag and liner described in U.S. Pat. Nos. 6,170,240, 5,125,526, and 4,869,049, each of which is herein incorporated by reference in its entirety.

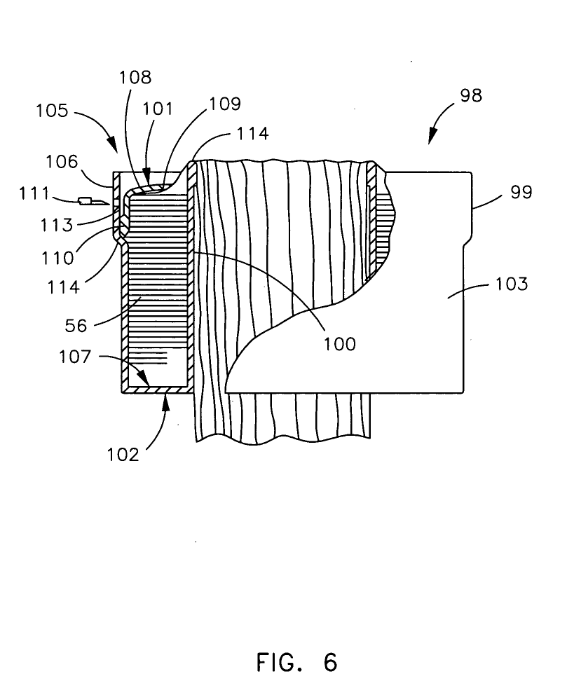

FIG. 6 is a side view, partly in section, of an exemplary cassette. Referring to FIG. 6, a cassette 98 for storing flexible tubing includes a rigid molded body 99 having a cylindrical inner core 100, a top 101, a bottom 102, and a cylindrical outer casing 103. The cylindrical outer casing 103 has an open top 105, an expanded portion 106 and an annular floor 107 joining the cylindrical inner core 100 and cylindrical outer casing 103.

Packed in the cassette 98 between the cylindrical inner core 100 and cylindrical outer casing 103 is a mass or pack of flexible tubing 56 that has been tightly folded/layered to fit into the space between the cylindrical inner core 100 and cylindrical outer casing 103. After the flexible tubing 56 has been packed, an annular cap 108 is placed over the pack of the flexible tubing 56.

Cap 108 has a top flange 109 and a cylindrical portion 110. The top flange 109 extends from the cylindrical outer casing toward, but not as far as, the cylindrical inner core 100. Three beveled piercing tools 111 are distributed around the cylindrical outer casing 103 to prevent the cap 108 from rising undesirably when mounted on a support or device for retaining the cassette. The piercing tools 111 are simultaneously operated to form tongues 112 (not shown) that are bent inwards from expanded portion 106 to engage in an annular V-shaped groove 113 formed in the cylindrical portion 110 of the cap 108. When the cap 108 is mounted, the flexible tubing 56 is slightly compressed and then immediately released whereupon the groove 112 is lifted to the tongues 111.

In use, the cassette 98 is mounted in a support or device for retaining the cassette 98 such as are known to those of ordinary skill in the art. For example, mounts and supports for holding the cassette 98 include those used to store soiled diapers. When mounted, the flexible tubing 56 is pulled or pushed through the cylindrical inner core 100, the flexible tubing 56 passing from the cassette 98 between the top flange 109 and cylindrical inner core 100 and then over the top edge 114 of the cylindrical inner core 100. Preferably, the top edge 114 is smooth or curved to avoid damaging the flexible tubing 56.

As the flexible tubing 56 is used, the cap descends toward annular floor 107. To prevent the cap 103 from descending and potentially getting wedged in the molded body 99, a junction 114 at the bottom of the cylindrical outer casing 103 acts as a stop.

In one embodiment, the flexible tubing 56 is from about 5 to about 10 inches in diameter. The diameter of the cylindrical inner core 100 is from about 3 to about 6 inches in diameter.

### EXAMPLES

The following examples, which are not intended to be limiting, present certain embodiments and advantages of the present invention. Unless otherwise indicated, any percentages are on a weight basis.

Blended films were extruded with a blown film extrusion process using a conventional 2.5 inch diameter extruders having a 24:1 screw length: screw diameter ratio. Film was produced at about 195 feet per minute. Extrusion conditions for extruder A included a first barrel temperature of about 350° Fahrenheit, a second barrel temperature of about 450° Fahrenheit, a third barrel temperature of about 495° Fahrenheit, and a fourth barrel temperature of about 490° Fahrenheit. The die temperature was about 485° Fahrenheit. The screw speed was about 85. The physical properties of the blended monolayer films were tested and measured as follows. Tests measured the tensile yield strength, tensile yield elongation, tensile break strength, tensile break elongation, graves tear, and the coefficient of friction.

Tensile modulus was measured by ASTM test D-882. Tensile yield strength, measured by ASTM test D-882, determined the force required to stretch a film beyond its elastic region. Tensile yield elongation, measured by ASTM test D-882, determined the amount of elongation that occurred before the film finally stretched away and yielded beyond its elastic point. Tensile break strength, measured by ASTM test D-882, determined the amount of force needed to break a film once stretched to its limit. Tensile break elongation, measured by ASTM test D-882, determined the quantity a film stretched before failure. Tear propagation was measured by ASTM test D-1938. Graves tear, measured by ASTM test D-1004, determined the amount of energy required to initially tear a film and then continue the tear. Films preferably have high graves tear values indicating that a large force is necessary to tear the film. Seal strength was measured by ASTM test F-88. The gauge thickness of each film was measured by ASTM test D-645.

Friction coefficients were determined using ASTM method D-1894. Coefficients of friction were determined between a test film and a polypropylene film. Unless otherwise indicated, coefficients of friction reported for each film are for the surface of film intended to contact a surface of a package disposal device.

Blended Monolayer Films

Blended monolayer thermoplastic films were produced and compared with a film composed of non-elastic polyester. The reference film, called Reference film, was composed of about 100% non-elastic polyester. The non-elastic polyester resin was a polybutylene terepthalate available from Ticona as trade name Celanex® 1700A. The Reference film was extruded using a conventional extruder. The Reference film had a hi/lo gauge thickness of 0.00070/0.00050 inches.

A first blended monolayer film, called Test Film A, was a blend of 95% non-elastic polyester and 5% polyester block copolymer. The polyester block copolymer resin was a polyether ester block copolymer, Arnitel® EM-630, available from DSM engineering. The non-elastic polyester resin was a polybutylene terepthalate, available from Ticona as Celanex® 1700A. The resins were admixed then extruded using a conventional extruder. Test Film A had a hi/lo gauge thickness of 0.00075/0.00050 inches.

A second blended monolayer film, called Test Film B, was a blend of 90% non-elastic polyester and 10% polyester block copolymer. The polyester block copolymer resin was a polyether ester block copolymer, available from DSM engineering as Arnitel® EM-630. The non-elastic polyester resin was a polybutylene terepthalate, available from Ticona as Celanex® 1700A. The resins were admixed then extruded using a conventional extruder. Test Film B had a hi/lo gauge thickness of 0.00075/0.00055 inches.

Test results for Test Films A and B are summarized in Table 1 as follows:

TABLE 1

| | Reference | | | | | |
|---|---|---|---|---|---|---|
| | Film* | | Test Film A | | Test Film B | |
| | Result | Std. Dev. | Result | Std. Dev. | Result | Std. Dev. |
| Tensile Yield | 2912 | 1315 | 3682 | 249 | 3305 | 421 |
| Strength MD (psi) | | | | | | |
| Tensile Yield | 956 | 1635 | Failure | | 3487 | 498 |
| Strength TD (psi) | | | | | | |
| Tensile Yield | 6.14 | 3.02 | 7.5 | 0.61 | 6.8 | 1.25 |
| Elongation MD, (%) | | | | | | |
| Tensile Yield | 1.57 | 2.7 | Failure | | 5.6 | 1.08 |
| Elongation TD, (%) | | | | | | |
| Tensile Break | 3202 | 452 | 3135 | 383 | 2966 | 494 |
| Strength MD (psi) | | | | | | |
| Tensile Break | 2907 | 344 | 3252 | 466 | 2910 | 462 |
| Strength TD (psi) | | | | | | |
| Tensile Break | 186.86 | 148.57 | 309.90 | 42.42 | 308.8 | 28.93 |
| Elongation MD, (%) | | | | | | |
| Tensile Break | 64.50 | 117.99 | Failure | | 265.60 | 64.66 |
| Elongation TD, (%) | | | | | | |
| Graves Tear | 692 | 125 | 781 | 97 | 732 | 79 |
| (gms-force/mil), MD | | | | | | |
| Graves Tear | 655 | 89 | 706 | 91 | 802 | 123 |
| (gms-force/mil), TD | | | | | | |
| Coefficient of Friction | 0.60 | 0.05 | 0.48 | 0.02 | 0.48 | 0.01 |

*The Reference film was tested for each of the above properties 7 times. Five of the seven tests resulted in “quick snap” failures. The test results described in Table 1 are for the two times the Reference film did not fail.

Test results show that Test Films A & B would be less likely to stretch under a given pressure compared to the Reference Film because higher forces are necessary to stretch the Test Films. The Reference film often failed under test conditions. Test Films A & B had higher tensile yield elongation values than the Reference film thereby indicating that the films will stretch farther before they tear compared to the reference film. Test films A and B had higher tensile break strength values compared to the reference film thereby indicating that more force is necessary to break the Test Films once stretched to their limit. Generally, test films A and B had higher tensile break elongation values compared to the reference film thereby indicating the Test Films are more difficult to break because they will yield/stretch more before breaking. Test film A broke when tested in the TD direction before a result was obtained. Test films A and B had higher graves tear values compared to the reference film thereby indicating the Test Films are more difficult to tear and continue to tear the films.

A third blended monolayer film, called Test Film C, was a blend of 95% non-elastic polyester and 5% polyolefin. The non-elastic polyester resin was a polybutylene terepthalate, Celanex® 1700A, available from Ticona. The polyolefin resin was a linear low density polyethylene, available from Eastman as SC74804X. The resins were admixed then extruded using a conventional extruder. Test Film C had a hi/lo gauge thickness of 0.00085/0.00050 inches.

A fourth blended monolayer film, called Test Film D, was a blend of 90% non-elastic polyester and 10% polyolefin. The non-elastic polyester resin was a polybutylene terepthalate, Celanex® 1700A, available from Ticona. The polyolefin resin was a linear low density polyethylene, available from Eastman as SC74804X. The resins were admixed then extruded using a conventional extruder. Test Film D had a hi/lo gauge thickness of 0.00085/0.00055 inches.

Test results for Test Films C and D are summarized in Table 2 as follows:

TABLE 2

| | Reference | | | | | |
|---|---|---|---|---|---|---|
| | Film* | | Test Film C | | Test Film D | |
| | Result | Std. Dev. | Result | Std. Dev. | Result | Std. Dev. |
| Tensile Yield | 2912 | 1315 | 3489 | 244 | 3421 | 429 |
| Strength MD (psi) | | | | | | |
| Tensile Yield | 956 | 1635 | 2611 | 398 | 3105 | 626 |
| Strength TD (psi) | | | | | | |
| Tensile Yield | 6.14 | 3.02 | 5.90 | 0.96 | 7.0 | 0.71 |
| Elongation MD, (%) | | | | | | |
| Tensile Yield | 1.57 | 2.7 | 5.40 | 0.55 | 5.6 | 0.65 |
| Elongation TD, (%) | | | | | | |
| Tensile Break | 3202 | 452 | 3135 | 105 | 3730 | 1461 |
| Strength MD (psi) | | | | | | |
| Tensile Break | 2907 | 344 | 2992 | 771 | 2903 | 762 |
| Strength TD (psi) | | | | | | |
| Tensile Break | 186.86 | 148.57 | 309.70 | 16.14 | 345.60 | 57.90 |
| Elongation MD, (%) | | | | | | |
| Tensile Break | 64.50 | 117.99 | 239.10 | 170.10 | 220.60 | 184.24 |
| Elongation TD, (%) | | | | | | |
| Graves Tear | 692 | 125 | 902 | 102 | 811 | 186 |
| (gms-force/mil), MD | | | | | | |
| Graves Tear | 655 | 89 | 877 | 89 | 810 | 93 |
| (gms-force/mil), TD | | | | | | |
| Coefficient of Friction | 0.60 | 0.05 | 0.40 | 0.02 | 0.37 | 0.02 |

*The Reference film was tested for each of the above properties 7 times. Five of the seven tests resulted in “quick snap” failures. The test results described in Table 1 are for the two times the Reference film did not fail.

Test results show that Test Films C & D would be more difficult to stretch compared to the Reference Film as exhibited by higher yield strength results. Test Films C & D also had higher tensile yield elongation values than the Reference film thereby indicating that the films will stretch farther before they tear compared to the reference film. Test results indicated that films C and D had similar tensile break strength values compared to the reference film. Higher tensile break elongation values were recorded for Test films C and D compared to the reference film thereby indicating the Test Films are more difficult to break because they will yield/stretch more before breaking. Test films C and D had higher graves tear values compared to the reference film thereby indicating the Test Films are more difficult to tear and continue to tear the films.

A fifth blended monolayer film, called Test Film E, was a blend of 95% non-elastic polyester and 5% polyolefin. The non-elastic polyester resin was a polybutylene terepthalate, Celanex® 1700A, available from Ticona. The polyolefin resin was a polypropylene copolymer, Adflex Q401F, available from Basell. The resins were admixed then extruded using a conventional extruder. Test Film E had a hi/lo gauge thickness of 0.00080/0.00050 inches.

A sixth blended monolayer film, called Test Film F, was a blend of 90% non-elastic polyester and 10% polyolefin. The non-elastic polyester resin was a polybutylene terepthalate, Celanex® 1700A, available from Ticona. The polyolefin resin was a polypropylene copolymer, Adflex Q401F, available from Basell. The resins were admixed then extruded using a conventional extruder. Test Film F had a hi/lo gauge thickness of 0.00080/0.00045 inches.

Test results for Test Films E and F are summarized in Table 3 as follows:

TABLE 3

| | Reference | | | | | |
|---|---|---|---|---|---|---|
| | Film* | | Test Film E | | Test Film F | |
| | Result | Std. Dev. | Result | Std. Dev. | Result | Std. Dev. |
| Tensile Yield | 2912 | 1315 | 3312 | 203 | 2632 | 296 |
| Strength MD | | | | | | |
| (psi) | | | | | | |
| Tensile Yield | 956 | 1635 | 1092 | 1009 | 1991 | 191 |
| Strength TD | | | | | | |
| (psi) | | | | | | |
| Tensile Yield | 6.14 | 3.02 | 7.01 | 0.93 | 6.00 | 0.94 |
| Elongation | | | | | | |
| MD, (%) | | | | | | |
| Tensile Yield | 1.57 | 2.7 | 3.00 | 2.74 | 5.6 | 1.08 |
| Elongation | | | | | | |
| TD, (%) | | | | | | |
| Tensile Break | 3202 | 452 | 3056 | 309 | 2794 | 819 |
| Strength MD | | | | | | |
| (psi) | | | | | | |
| Tensile Break | 2907 | 344 | 2104 | 589 | 2744 | 464 |
| Strength TD | | | | | | |
| (psi) | | | | | | |
| Tensile Break | 186.86 | 148.57 | 312.30 | 10.86 | 327.1 | 67.58 |
| Elongation | | | | | | |
| MD, (%) | | | | | | |
| Tensile Break | 64.50 | 117.99 | 21.30 | 28.54 | 388.0 | 33.47 |
| Elongation | | | | | | |
| TD, (%) | | | | | | |
| Graves Tear | 692 | 125 | 645 | 61 | 522 | 34 |
| (gms-force/mil), MD | | | | | | |
| Graves Tear | 655 | 89 | 611 | 52 | 530 | 67 |
| (gms-force/mil), TD | | | | | | |
| Coefficient of Friction | 0.60 | 0.05 | 0.47 | 0.02 | 0.41 | 0.03 |

*The Reference film was tested for each of the above properties 7 times. Five of the seven tests resulted in “quick snap” failures. The test results described in Table 1 are for the two times the Reference film did not fail.

Test Films E & F had higher tensile yield elongation values than the Reference film thereby indicating that the films will stretch farther before they tear compared to the reference film. Test results show that Test films E and F had lower tensile break strength values compared to the reference film thereby indicating that less force is necessary to tear the Test Films once stretched to their limit. Higher tensile break elongation values were recorded for Test films E and F compared to the reference film thereby indicating the Test Films are more difficult to break because they will yield/stretch more before breaking.

Test films A, B, C, D, E, and F were tested for odor barrier properties. Human baby feces was placed in a diaper and sealed in a bag made from each of the Test Films. Volunteers were then asked every day for 6 days whether an odor was detected from the bag. No odors were detected from any of the bags after three days. No odors were detected from Test films B and D after 6 days.

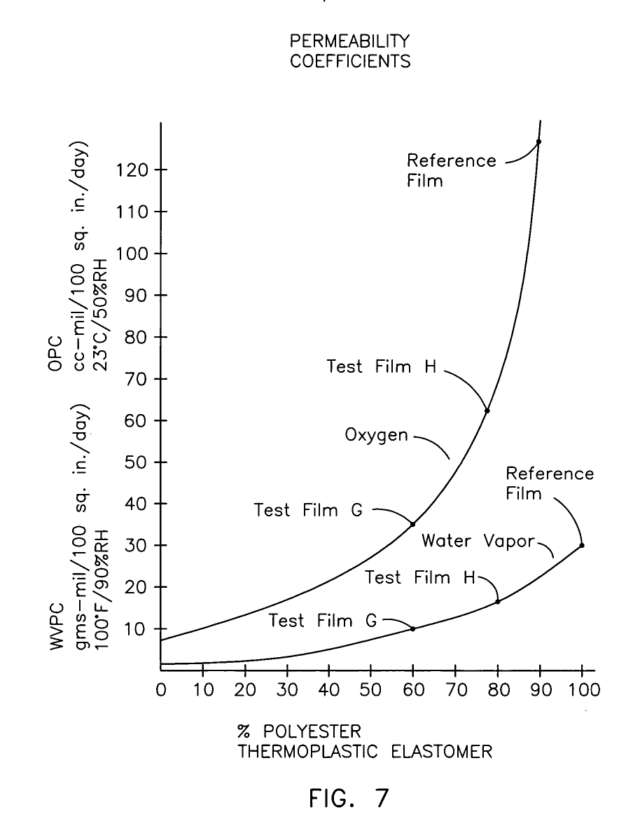

FIG. 7 is a graph of oxygen and water vapor permeability coefficients for blended monolayer films. Referring to FIG. 7, films were tested to measure the oxygen transmission rate and water vapor transmission rate of blended monolayer films. A Reference Film was prepared composed of 100% polyester thermoplastic elastomer commercially available from DSM as Arnitel® EM-630. The reference film had a hi/lo gauge thickness of 0.00250/0.00175 inches. A seventh sixth blended monolayer film, called Test Film G, was a blend of 40% non-elastic polyester and 60% polyester thermoplastic elastomer. The non-elastic polyester resin was a polybutylene terepthalate, Celanex® 1700A, available from Ticona. The polyester thermoplastic elastomer resin was a polyether-ester block copolymer, Arnitel® EM-630, available from DSM. The resins were admixed then extruded using a conventional extruder. Test Film G had a hi/lo gauge thickness of 0.00185/0.00145 inches.

An eighth blended monolayer film, called Test Film H, was a blend of 20% non-elastic polyester and 80% polyester thermoplastic elastomer. The non-elastic polyester resin was a polybutylene terepthalate, Celanex® 1700A, available from Ticona. The polyester thermoplastic elastomer resin was a polyether-ester block copolymer, Arnitel® EM-630, available from DSM. The resins were admixed then extruded using a conventional extruder. Test Film H had a hi/lo gauge thickness of 0.00170/0.00145 inches.

A film's oxygen transmission rate measures the amount of oxygen that can permeate through a film. A permeability coefficient was used to standardize the oxygen transmission rate to a 1.0-mil film. When comparing films it is best to compare standardized values so that deviations in film thickness do not distort the test results. The results show that blended monolayer films made of non-elastic polyester and polyester thermoplastic elastomer provide a much better oxygen barrier when compared to films made from only polyester thermoplastic elastomer.

Similarly, water vapor transmission rates measures the amount of water vapor that can permeate through a film. The permeability coefficient standardizes the rate to a 1.0-mil film. Again, when comparing films, it is best to compare standardized values. Oxygen and water vapor transmission rates were measured by ASTM tests F-1927 and F-1249 respectively.

The test results are summarized in Table 4 as follows:

TABLE 4

| | Oxygen | |
|---|---|---|
| | Permeability | Water Vapor |
| | Coefficient | Permeability |
| | (cc-mil/100 sq. in./day) | Coefficient |
| | at 23° C. and | (gms-mil/100 sq. in./day) |
| | 50% relative | at 100° F. and 90% |
| | humidity | relative humidity |
| Reference | 126.010 | 33.363 |
| Film | | |
| Test Film G | 34.650 | 10.313 |
| Test Film H | 62.134 | 17.089 |

A ninth blended monolayer film, called Test Film J, was a blend of 70% non-elastic polyester, 25% polyolefin, and 5% slip additive. The non-elastic polyester was a polybutylene terepthalate, Celanex® 1700A, available from Ticona. The polyolefin was a ultra low density polyethylene/octene copolymer, Attane™ 4301G, available from Dow. The slip additive contained 67.5% low density polyethylene, 25% diatomaceous earth antiblock additive, 5% euricamide slip additive and 2.5% Irganox 1098 thermal stabilizer, PELD 1074, available from Plastics Color & Compounding, Inc. The resins were admixed then extruded using a conventional extruder. Test Film J had a hi/lo gauge thickness of 0.00095/0.00075 inches., with an average thickness of 0.00080 inches.

A second Reference film, called Reference Film 2, was composed of about 100% non-elastic polyester. The non-elastic polyester resin was a polybutylene terepthalate available from Ticona as trade name Celanex® 1700A. Reference Film 2 was extruded using conventional extruding techniques. Reference Film 2 had a hi/low gauge thickness of 0.00095/0.00070 inches, with an average thickness of 0.00080 inches.

Test results for Test Film J and Reference Film 2 are summarized in Table 5 as follows:

TABLE 5

| | Reference Film 2 | | Test Film J | |
|---|---|---|---|---|
| | Result | Std. Dev. | Result | Std. Dev. |
| Tensile Yield | 5042 | 981 | 3602 | 373 |
| Strength MD, | | | | |
| (psi) | | | | |
| Tensile Yield | 4773¹ | 802 | 2743 | 358 |
| Strength TD | | | | |
| (psi) | | | | |
| Tensile Yield | 19.00% | 2.24% | 24.50% | 1.12% |
| Elongation | | | | |
| MD, (%) | | | | |
| Tensile Yield | 18.33%¹ | 1.44% | 16.50% | 2.85% |
| Elongation TD, | | | | |
| (%) | | | | |
| Tensile Break | 7512 | 2347 | 6318 | 580 |
| Strength MD, | | | | |
| (psi) | | | | |
| Tensile Break | 4257 | 1484 | 3987 | 584 |
| Strength TD, | | | | |
| (psi) | | | | |
| Tensile Break | 418.30% | 68.98% | 423.90% | 35.65% |
| Elongation | | | | |
| MD, (%) | | | | |
| Tensile Break | 363.00% | 109.53% | 455.00% | 17.23% |
| Elongation TD, | | | | |
| (%) | | | | |
| Tear | 58 | 4 | 16 | 2 |
| Propagation | | | | |
| MD, (gms- | | | | |
| force) | | | | |
| Tear | 117 | 16 | 151 | 11 |
| Propagation | | | | |
| TD, (gms- | | | | |
| force) | | | | |
| Graves Tear | 660 | 51 | 422 | 31 |
| MD, (gms- | | | | |
| force/mil) | | | | |
| Graves Tear | 794 | 72 | 480 | 41 |
| TD, (gms- | | | | |
| force/mil) | | | | |
| Coefficient of | | | | |
| Friction: | | | | |
| Inside to Inside | 0.34 | 0.02 | 0.32 | 0.01 |
| Outside to | 0.31 | 0.01 | 0.27 | 0.01 |
| Outside | | | | |
| Inside to Poly | 0.23 | 0.03 | 0.13 | 0.01 |
| | | | 0.16² | 0.01 |

¹Four out of the seven tests of Reference Film 2 showed transverse direction breaks with no yield or elongation.
²This test was performed twice on Test Film J and yielded consistent results.

As shown above, Test Film J was more likely to stretch and not break under a given pressure compared to Reference Film 2. Test Film J exhibited better yield and elongation properties, whereas Reference Film 2 often failed under the test conditions.

The coefficient of friction was measured film to film for both the inside and outside of the film tube. Test Film J and Reference Film 2 had similar film to film slip characteristics. The coefficient of friction was also measured for the inside of the film tube to a polypropylene (Poly) film. Test Film J had a much lower coefficient of friction than Reference Film 2.

The barrier properties of Test Film J were also evaluated, the results of which are presented below in Table 6. Water Vapor Transmission (WVTR) was measured at 100° F. and 90% relative humidity. The values measured were 2.02 gm/100 sq. in./day for Test Film J and 2.28 gms/100 sq. in./day for Reference Film 2. These values were standardized to 1.0 mil to achieve a permeability coefficient, yielding a value of 1.7 gms-mil/100 sq. in./day for Test Film J and 1.9 gms-mil/100 sq. in./day for Reference Film 2. Both films exhibited good moisture barrier properties.

Oxygen Transmission Rates (OTR) were also measured, the results of which are presented below in Table 6. OTR were measured at 23° C. and 50% relative humidity. A value of 14.75 cc/100 sq. in./day was measured for Test Film J, and a value of 5.79 cc/sq. in./day for Reference Film 2. These values were standardized to 1.0 mil to achieve an oxygen permeability coefficient (OPC) of 12.54 cc-mil/100 sq. in./day for Test Film J and 4.92 cc-mil/100 sq. in./day for Reference Film 2. This data indicates that Test Film J transmits similar quantities of water vapor over a given period compared to Reference Film 2, but transmits oxygen faster than Reference Film 2.

TABLE 6

| | Oxygen | |
|---|---|---|
| | Permeability | Water Vapor |
| | Coefficient | Permeability |
| | (cc-mil/100 sq. in./day) | Coefficient |
| | at 23° C. and | (gms-mil/100 sq. in./day) |
| | 50% relative | at 100° F. and 90% |
| | humidity | relative humidity |
| Reference | 4.92 | 1.938 |
| Film 2 | | |
| Test Film J | 12.54 | 1.713 |

Multilayered Films

Multilayered films were compared to a film composed of 100% non-elastic polyester. A Reference Film composed of 100% polyester thermoplastic elastomer commercially was prepared using Arnitel® EM-630 available from DSM. The reference film had a hi/lo gauge thickness of 0.00225/0.00175 inches.

A first multilayered film, called Test Film I, included a first layer of non-elastic polyester and a second layer of polyester block copolymer. The polyester block copolymer resin was a polyester thermoplastic elastomer, Arnitel® EM-630, available from DSM engineering. The non-elastic polyester resin was a polybutylene terepthalate, Celanex® 1700A, available from Ticona. The first and second layers were coextruded using a conventional extruder. The first layer of non-elastic polyester had a gauge thickness of 0.0017 inches and the second layer of polyester block copolymer had a gauge thickness of 0.00050 inches.

Test results for the Reference Film and Test Film I are summarized in Table 7 as follows:

TABLE 7

| | |
|---|---|
| Reference | |
| Film | Test Film I |

| | Result | Std. Dev. | Result | Std. Dev. |
|---|---|---|---|---|
| Tensile | 35172 | 808 | 190448 | 2711 |
| Modulus MD | | | | |
| (psi) | | | | |
| Tensile | 34101 | 2590 | 202895 | 12560 |
| Modulus TD | | | | |
| (psi) | | | | |
| Tensile Yield | 3255 | 1344.48 | 5183 | 60.36 |
| Strength MD | | | | |
| (psi) | | | | |
| Tensile Yield | 2620 | 90.87 | 5566 | 154.6 |
| Strength TD | | | | |
| (psi) | | | | |
| Tensile Yield | 19.50 | 1.12 | 5.1 | 0.22 |
| Elongation | | | | |
| MD, (%) | | | | |
| Tensile Yield | 18.00 | 1.12 | 5.6 | 0.82 |
| Elongation | | | | |
| TD, (%) | | | | |
| Tensile Break | 9143 | 702.27 | 9496 | 742.36 |
| Strength MD | | | | |
| (psi) | | | | |
| Tensile Break | 8573 | 624.0 | 6624 | 2421.61 |
| Strength TD | | | | |
| (psi) | | | | |
| Tensile Break | 533.0 | 30.03 | 400 | 16.7 |
| Elongation | | | | |
| MD, (%) | | | | |
| Tensile Break | 534.7 | 22.0 | 337.9 | 76.92 |
| Elongation | | | | |
| TD, (%) | | | | |
| Tear | 612 | 37 | 204 | 32 |
| Propagation | | | | |
| MD (gms- | | | | |
| force/mil) | | | | |
| Tear | 673 | 23 | 232 | 20 |
| Propagation | | | | |
| TD (gms- | | | | |
| force/mil) | | | | |
| Graves Tear | 473 | 23 | 560 | 97 |
| (gms-force/ | | | | |
| mil), MD | | | | |
| Graves Tear | 520 | 32 | 728 | 40 |
| (gms-force/ | | | | |
| mil), TD | | | | |
| Seal Strength | 5.4 | 0.19 | 8.23 | 0.36 |
| Lbs-force/in | | | | |
| Impulse | | | | |
| setting 6 | | | | |
| Seal Strength | 5.43 | 0.12 | 8.58 | 0.34 |
| Lbs-force/in | | | | |
| Impulse | | | | |
| setting 8 | | | | |

Test results show that greater forces are necessary to stretch Test Film I compared to the Reference Film. Test Film I had higher graves tear values compared to the Reference Film indicating Test Film I is more difficult to tear. Test Film I formed stronger seals compared to the Reference Film.

Oxygen and water vapor transmission rates were measured by ASTM tests F-1927 and F-1249 respectively. The test results are summarized in Table 8 as follows:

TABLE 8

| | Oxygen | |
|---|---|---|
| | Permeability | Water Vapor |
| | Coefficient | Permeability |
| | (cc-mil/100 sq. in./day) | Coefficient |
| | at 23° C. and | (gms-mil/100 sq. in./day) |
| | 50% relative | at 100° F. and 90% |
| | humidity | relative humidity |
| Reference | 126.010 | 33.363 |
| Film | | |
| Test Film I | 9.427 | 3.199 |

Test Film I exhibits superior barrier properties compared to the reference film.

Those skilled in the art will appreciate that numerous changes and modifications may be made to the preferred embodiments of the invention and that such changes and modifications may be made without departing from the spirit of the invention. It is therefore intended that the appended claims cover all such equivalent variations as fall within the true spirit and scope of the invention.

1. A blended monolayer thermoplastic film comprising:
a non-elastic polyester comprising:
from about 25 to about 75 weight percent, based on the total weight of the blended monolayer thermoplastic film, of polyethylene terepthalate, and
from about 25 to about 75 weight percent, based on the total weight of the blended monolayer thermoplastic film, of polybutylene terepthalate,
wherein said blended monolayer thermoplastic film has a thickness of about 0.00015 to about 0.01 inches, said blended monolayer thermoplastic film providing a substantial odor barrier for at least 3 days.

2. The blended monolayer thermoplastic film of claim 1, wherein said film consists of from about 55 to about 65 weight percent polyethylene terepthalate, from about 35 to about 45 weight percent polybutylene terepthalate, and less than 5 weight percent of at least one film additive.

3. The blended monolayer thermoplastic film of claim 1, further comprising from about from about 0.05 to about 10 weight percent, based on the total weight of said blended monolayer thermoplastic film, of at least one film additive selected from the group consisting of compatalizers, impact modifiers, slip and antiblock additives, fragrance additives, de-odorizers, antimicrobial agents, and combinations thereof.

4. A blended monolayer thermoplastic film comprising:
from about 40 to about 99 weight percent, based on the total weight of said blended monolayer thermoplastic film, of non-elastic polyester; and
from about 1 to about 60 weight percent based on the total weight of said blended monolayer thermoplastic film, of polyester thermoplastic elastomer;
wherein said blended monolayer thermoplastic film has a thickness of about 0.00015 to about 0.01 inches, said blended monolayer thermoplastic film providing a substantial odor barrier for at least 3 days.

5. The blended monolayer thermoplastic film of claim 4, wherein said film consists of from about 60 to about 95 weight percent non-elastic elastomer, from about 5 to about 40 weight percent polyester block co-polymer, and less than 5 weight percent of at least one film additive.

6. The blended monolayer thermoplastic film of claim 4, wherein said polyester thermoplastic elastomer is polyester-ester block copolymers, polyether-ester block copolymers, or combinations thereof.

7. The blended monolayer thermoplastic film of claim 4, wherein the non-elastic polyester is polybutylene terepthalate, polyethylene terepthalate, or combinations thereof.

8. The blended monolayer thermoplastic film of claim 4, further comprising from about 1 to about 60 weight percent, based on the total weight of said blended monolayer thermoplastic film, of polyolefin.

9. The blended monolayer thermoplastic film of claim 4, wherein said polyolefin is selected from the group consisting of linear low density polyethylene, low density polyethylene, high density polyethylene, polypropylene, polypropylene copolymer, ethylene vinyl acetate.

10. The blended monolayer thermoplastic film of claim 4, further comprising from about from about 0.025 to about 10 weight percent, based on the total weight of said blended monolayer thermoplastic film, of at least one film additive selected from the group consisting of compatalizers, impact modifiers, slip and antiblock additives, fragrance additives, de-odorizers, antimicrobial agents, and combinations thereof.

11. The blended monolayer thermoplastic film of claim 10, wherein said at least one film additive is disposed on the exterior surface of the blended monolayer thermoplastic film.

12. A blended monolayer thermoplastic film comprising:
from about 40 to about 99 weight percent, based on the total weight of said blended monolayer thermoplastic film, of non-elastic polyester;
from about 1 to about 60 weight percent based on the total weight of said blended monolayer thermoplastic film, of polyolefin; and
wherein said blended monolayer thermoplastic film has a thickness of about 0.00015 to about 0.01 inches, said blended monolayer thermoplastic film providing a substantial odor barrier for at least 3 days.

13. The blended monolayer thermoplastic film of claim 12, wherein said film consists of from about 60 to about 95 weight percent non-elastic polyester, from about 5 to about 40 weight percent polyolefin, and less than 5 weight percent of at least one film additive.

14. The blended monolayer thermoplastic film of claim 12, wherein the non-elastic polyester is polybutylene terepthalate, polyethylene terepthalate, or combinations thereof.

15. The blended monolayer thermoplastic film of claim 12, further comprising from about from about 0.025 to about 10 weight percent, based on the total weight of said blended monolayer thermoplastic film, of at least one film additive selected from the group consisting of compatalizers, impact modifiers, slip and antiblock additives, fragrance additives, de-odorizers, antimicrobial agents, and combinations thereof.

16. The blended monolayer thermoplastic film of claim 15, wherein said at least one film additive is disposed on the exterior surface of the blended monolayer thermoplastic film.

17. The blended monolayer thermoplastic film of claim 12 wherein the polyolefin is linear low density polyethylene, low density polyethylene, high density polyethylene, polypropylene, ethylene vinyl acetate, or polypropylene copolymers.

18. A multi layer thermoplastic film comprising: z
a plurality of layers of film comprising:
from about 40 to about 99 weight percent, based on the total weight of said multi layer thermoplastic film, of at least one non-elastic polyester layer of film, and
from about 1 to about 60 weight percent, based on the total weight of said multi layer thermoplastic film, at least one additional layer of film selected from the group consisting of:
at least one polyester thermoplastic elastomer layer of film,
at least one polyolefin layer of film,
at least one nylon layer of film, and
combinations thereof,
said plurality of layers of film having an exterior film layer having an outer surface, said exterior film layer comprising either the at least one non-elastic polyester layer of film or the at least one additional layer of film, wherein said multi layer thermoplastic film has a thickness of about 0.00015 to about 0.01 inches, said multi layer thermoplastic film providing a substantial odor barrier for at least 3 days.

19. The multi layer thermoplastic film of claim 18, wherein said polyester thermoplastic elastomer is polyester-ester block copolymers, polyether-ester block copolymers, or combinations thereof.

20. The multi layer thermoplastic film of claim 18, wherein the non-elastic polyester is polybutylene terepthalate, polyethylene terepthalate, or combinations thereof.

21. The multi layer thermoplastic film of claim 18, wherein said polyolefin is a linear low density polyethylene, low density polyethylene, high density polyethylene, polypropylene, ethylene vinyl acetate, or polypropylene copolymer.

22. The multi layer thermoplastic film of claim 18, wherein said exterior film layer is a non-elastic polyester layer of film.

23. The multi layer thermoplastic film of claim 18, wherein said exterior film layer is a polyester thermoplastic elastomer layer of film.

24. The multi layer thermoplastic film of claim 18, wherein said exterior film layer is a polyolefin layer of film.

25. The multi layer thermoplastic film of claim 18, further comprising at least one adhesive layer disposed between each layer of said plurality of layers of film.

26. The multi layer thermoplastic film of claim 18, wherein the plurality of layers of film comprise:
(a) an exterior film layer comprising a polyester thermoplastic elastomer layer of film,
(b) a non-elastic polyester layer of film disposed on the exterior film layer,
(c) a polyolefin layer of film disposed on the non-elastic polyester layer, and
(d) a second polyester thermoplastic elastomer layer of film disposed on the polyolefin layer of film.

27. A method of fabricating the multilayered thermoplastic film of claim 18 comprising:
co-extruding each of said plurality of layers of film to form said multilayered thermoplastic film.

28. A method of fabricating the multilayered thermoplastic film of claim 18 comprising:
extruding said first layer, extruding said second layer, disposing said second layer on said first layer, and rolling said first layer and said second layer between a heated roller to form said multilayered thermoplastic film.

29. A method of fabricating the multilayered thermoplastic film of claim 18 comprising:
extruding each of said plurality of layers of film, and
joining each of said plurality of layers of film together by disposing an interleaving adhesive layer between each of said plurality of layers of film.

30. A bag for holding waste comprising:
a sealed end;
at least one side wall extending away from said sealed end, each of said at least one side wall having a distal edge; and
an open end defined by said distal edge;
said bag formed from the blended thermoplastic film of claim 1.

31. A bag for holding waste of claim 30, wherein said film consists of from about 55 to about 65 weight percent polyethylene terepthalate, from about 35 to about 45 weight percent polybutylene terepthalate, and less than 5 weight percent of at least one film additive.

32. A bag for holding waste of claim 30, further comprising from about from about 0.025 to about 10 weight percent, based on the total weight of said blended monolayer thermoplastic film, of at least one film additive selected from the group consisting of compatalizers, impact modifiers, slip and antiblock additives, fragrance additives, de-odorizers, antimicrobial agents, and combinations thereof.

33. A bag for holding waste and providing an odor barrier comprising:
a sealed end;
at least one side wall extending away from said sealed end, each of said at least one side wall having a distal edge; and
an open end defined by said distal edge;
said bag formed from the blended monolayer thermoplastic film of claim 4.

34. The bag for holding waste and providing an odor barrier of claim 33, wherein said film consists of from about 60 to about 95 weight percent non-elastic elastomer, from about 5 to about 40 weight percent polyester block co-polymer, and less than 5 weight percent of at least one film additive.

35. The bag for holding waste and providing an odor barrier of claim 33, wherein said polyester thermoplastic elastomer is polyester-ester block copolymers, polyether-ester block copolymers, or combinations thereof.

36. The bag for holding waste and providing an odor barrier of claim 33, wherein the non-elastic polyester is polybutylene terepthalate, polyethylene terepthalate, or combinations thereof.

37. The bag for holding waste and providing an odor barrier of claim 33, further comprising from about 1 to about 60 weight percent, based on the total weight of said blended monolayer thermoplastic film, of polyolefin.

38. The bag for holding waste and providing an odor barrier of claim 33, wherein said polyolefin is selected from the group consisting of linear low density polyethylene, low density polyethylene, high density polyethylene, polypropylene, polypropylene co-polymer, or ethylene vinyl acetate.

39. The bag for holding waste and providing an odor barrier of claim 33, further comprising from about from about 0.025 to about 10 weight percent, based on the total weight of said blended monolayer thermoplastic film, of at least one film additive selected from the group consisting of compatalizers, impact modifiers, slip and antiblock additives, fragrance additives, de-odorizers, antimicrobial agents, and combinations thereof.

40. The bag for holding waste and providing an odor barrier of claim 39, wherein said at least one film additive is disposed on the exterior surface of the blended monolayer thermoplastic film.

41. A bag comprising:
a sealed end;
at least one side wall extending away from said sealed end, each of said at least one side wall having a distal edge; and
an open end defined by said distal edge;
said bag formed from the blended monolayer thermoplastic film of claim 12.

42. The bag of claim 41, wherein said film consists of from about 60 to about 95 weight percent non-elastic polyester, from about 5 to about 40 weight percent polyolefin, and less than 5 weight percent of at least one film additive.

43. The bag of claim 41, wherein the non-elastic polyester is polybutylene terepthalate, polyethylene terepthalate, or combinations thereof.

44. The bag of claim 41, wherein said polyolefin is selected from the group consisting of linear low density polyethylene, low density polyethylene, high density polyethylene, polypropylene, polypropylene copolymer, or ethylene vinyl acetate.

45. The bag of claim 41, further comprising from about from about 0.025 to about 10 weight percent, based on the total weight of said blended monolayer thermoplastic film, of at least one film additive selected from the group consisting of compatalizers, impact modifiers, slip and antiblock additives, fragrance additives, de-odorizers, antimicrobial agents, and combinations thereof.

46. The bag of claim 45, wherein said at least one film additive is disposed on the exterior surface of the blended monolayer thermoplastic film.

47. The bag of claim 41, wherein said bag provides an odor barrier to human olfactory senses for at least 3 days.

48. A bag comprising:
a sealed end;
at least one side wall extending away from said sealed end, each of said at least one side wall having a distal edge; and
an open end defined by said distal edge;
said bag formed from the multilayered thermoplastic film of claim 18.

49. The bag of claim 48, wherein said polyester thermoplastic elastomer is polyester-ester block copolymers, polyether-ester block copolymers, or combinations thereof.

50. The bag of claim 48, wherein the non-elastic polyester is polybutylene terepthalate, polyethylene terepthalate, or combinations thereof.

51. The bag of claim 48, wherein said polyolefin is a linear low density polyethylene, low density polyethylene, high density polyethylene, polypropylene, ethylene vinyl acetate, or polyethylene copolymer.

52. The bag of claim 48, wherein said exterior film layer is a non-elastic polyester layer of film.

53. The bag of claim 48, wherein said exterior film layer is a polyester thermoplastic elastomer layer of film.

54. The bag of claim 48, wherein said exterior film layer is a polyolefin layer of film.

55. The bag of claim 48, further comprising at least one adhesive layer disposed between each layer of said plurality of layers of film.

56. The bag of claim 48, wherein said bag provides an odor barrier to human olfactory senses for at least 3 days.

57. The bag of claim 48, wherein the plurality of layers of film comprise:
(a) an exterior film layer comprising a polyester thermoplastic elastomer layer of film,
(b) a non-elastic polyester layer of film disposed on the exterior film layer,
(c) a polyolefin layer of film disposed on the non-elastic polyester layer, and
(d) a second polyester thermoplastic elastomer layer of film disposed on the polyolefin layer of film.

58. A blended monolayer thermoplastic film comprising:
from about 25 to about 75 weight percent, based on the total weight of the blended monolayer thermoplastic film, of non-elastic polyester,
from about 1 to about 40 weight percent, based on the total weight of the blended monolayer thermoplastic film, of polyolefin, and
from about 0.1 to about 10 weight percent, based on the total weight of the blended monolayer thermoplastic film, of a slip/antiblock composition,
wherein said blended monolayer thermoplastic film has a thickness of about 0.00015 to about 0.01 inches, said blended monolayer thermoplastic film providing a substantial odor barrier for at least 3 days.

59. The blended monolayer thermoplastic film of claim 58, wherein said film consists of from about 65 to about 75 weight percent of non-elastic polyester, from about 20 to about 30 weight percent polyolefin, and from about 1 to 5 weight percent slip/antiblock composition.

60. The blended monolayer thermoplastic film of claim 58, wherein non-elastic polyester is polybutylene terepthalate.

61. The blended monolayer thermoplastic film of claim 58, wherein said polyolefin is ultra low density polyethylene/octene copolymer.

62. The blended monolayer thermoplastic film of claim 58, wherein said slip/antiblock composition comprises:
from about 60 to about 70 weight percent of low density polyethylene;
from about 20 to about 30 weight percent of diatomaceouse earth antiblock additive;
from about 1 to about 10 weight percent of euricamide slip additive; and
from about 1 to about 5 weight percent, based on the total weight of said slip/antiblock composition, thermal stabilizer.

63. The blended monolayer thermoplastic film of claim 58, wherein said film consists of about 70 weight percent of polubutylene terpthalate, about 25 weight percent ultra low density ethylene/octene copolymer, and about 5 weight percent slip/antiblock composition, wherein said slip/antiblock composition comprises about 67.5 weight percent low density polyethylene, about 25 weight percent diatomaceous earth antiblock additive, about 5 weight percent euricamide slip additive, and about 2.5 weight percent thermal stabilizer.

64. A bag for holding waste comprising:
a sealed end;
at least one side wall extending away from said sealed end, each of said at least one side wall having a distal edge; and
an open end defined by said distal edge;
said bag formed from the blended monolayer thermoplastic film of claim 58.

65. A bag for holding waste of claim 64, wherein said film consists of from about 65 to about 75 weight percent polybutylene terepthalate, from about 20 to about 30 weight percent ultra low density ethylene/octene copolymer, and 1 to 5 weight percent slip/antiblock composition, wherein said slip and antiblock additive comprises about 67.5 weight percent low density polyethylene, about 25 weight percent diatomaceous earth antiblock additive, about 5 weight percent euricamide slip additive, and about 2.5 weight percent thermal stabilizer.

66. A bag comprising:
a sealed end;
at least one side wall extending away from said sealed end, each of said at least one side wall having a distal edge; and
an open end defined by said distal edge;
said bag formed from the blended monolayer thermoplastic film of claim 58.

67. The bag of claim 66, wherein said film consists of from about 65 to about 75 weight percent non-elastic polyester, from about 20 to about 30 weight percent polyolefin, and from about 1 to about 5 weight percent of slip/antiblock composition.

68. The bag of claim 66, wherein the non-elastic polyester is polybutylene terepthalate.

69. The bag of claim 66, wherein said polyolefin is ultra low density ethylene/octene copolymer.

70. The bag of claim 66, wherein said slip/antiblock composition comprises about 67.5 weight percent low density polyethylene, about 25 weight percent diatomaceous earth antiblock additive, about 5 weight percent euricamide slip additive, and about 2.5 weight percent thermal stabilizer.
